(19) United States
(12) Patent Application Publication
(10) Pub. No.: US 2022/0305563 A1
(43) Pub. Date: Sep. 29, 2022

(54) SKIVING MACHINE AND SKIVING METHOD

(71) Applicants: National University Corporation Tokai National Higher Education and Research System, Nagoya-shi (JP); Nagoya Institute of Technology, Nagoya-shi (JP); Murata Machinery, Ltd., lnuyama-shi (JP)

(72) Inventors: Eiji SHAMOTO, Nagoya-shi (JP); Fumihiro ITOIGAWA, Nagoya-shi (JP); Ryuzo MORI, Inuyama-shi (JP)

(21) Appl. No.: 17/642,476

(22) PCT Filed: Aug. 18, 2020
(86) PCT No.: PCT/JP2020/031049

§ 371 Date: Mar. 11, 2022

(30) Foreign Application Priority Data
Sep. 13, 2019 (JP) 2019-167321

(51) Int. Cl. B23B 5/08; B23B 1/00

(52) U.S. Cl. CPC B23B 5/08; B23B 1/00

(57) ABSTRACT

A rotation mechanism 9 rotates a spindle 2a to which a workpiece 6 is attached. A feed mechanism 8 feeds a cutting edge 4a positioned obliquely relative to a rotation axis of the workpiece 6 in a direction containing a cutting direction component orthogonal to the rotation axis with the cutting edge 4a cutting into the workpiece 6 to machine a surface of the workpiece 6. The cutting edge 4a of a cutting tool 4 has been formed by scanning a cylindrical irradiation region including a focused spot of laser light over a diamond-coated layer of a chip base material.

### CROSS REFERENCE TO RELATED APPLICATIONS

This application is based upon and claims the benefit of priority from Japanese Patent Application No. 2019-167321, filed on Sep. 13, 2019, the entire contents of which are incorporated herein by reference.

### TECHNICAL FIELD

The present disclosure relates to a skiving machine and a skiving method.

### BACKGROUND ART

A machining method called hard skiving is known. In this machining method, a cutting edge positioned obliquely relative to a rotation axis of a workpiece is fed in a direction containing a cutting direction component orthogonal to the rotation axis with the cutting edge cutting into the workpiece to machine a surface of the workpiece (for example, Patent Literature 1). In a skiving process, a straight cutting edge positioned obliquely turns a cylindrical surface in a longitudinal direction, so that it is possible to reduce geometric roughness (theoretical roughness) in a tool feed direction and obtain a satisfactory finished surface. Further, moving the cutting tool in the cutting direction shifts a contact position of the cutting edge with the surface of the workpiece from one end of the cutting edge toward the other end. This allows the cutting edge to wear in a dispersed manner and can make the life of the tool longer.

### PATENT LITERATURE

[Patent Literature 1] JP3984052 B

### SUMMARY OF INVENTION

### Technical Problem

The application of the hard skiving process to finishing of hardened steel shafts that are required to have highly accurate cylindrical surfaces has been proposed. In this finishing process, a cubic boron nitride (CBN) tool, which is considered to be suitable for cutting hardened steel, is used as a cutting tool. The CBN tool, however, is relatively expensive and has a cutting edge less sharp than a cutting edge of a monocrystalline diamond tool, so that a satisfactory finished surface roughness equivalent to mirror finishing cannot be obtained.

On the other hand, the monocrystalline diamond tool has a sharp cutting edge applicable to mirror finishing, but is more expensive than the CBN tool, and the size of the cutting edge cannot be increased, which makes machining efficiency low. One of the characteristics of the hard skiving process is that a cylindrical surface can be turned with an obliquely-positioned straight cutting edge with high efficiency, but the cutting edge of the monocrystalline diamond cannot be made long, so that it is not possible to make the most of the advantage of the hard skiving process.

The present disclosure has been made in view of such circumstances, and it is therefore an object of the present disclosure to provide a technique for allowing a skiving process to be performed with high efficiency.

### Solution to Problem

In order to solve the above-described problems, a skiving machine according to an aspect of the present disclosure includes a rotation mechanism structured to rotate a spindle to which a workpiece is attached, and a feed mechanism structured to feed a cutting edge positioned obliquely relative to a rotation axis of the workpiece in a direction containing a cutting direction component orthogonal to the rotation axis with the cutting edge cutting into the workpiece. The cutting edge of a cutting tool has been formed by scanning a cylindrical irradiation region including a focused spot of laser light over a diamond-coated layer.

Another aspect of the present disclosure is a skiving method for machining a surface of a workpiece by feeding a cutting edge positioned obliquely relative to a rotation axis of the workpiece in a direction containing a cutting direction component orthogonal to the rotation axis with the cutting edge cutting into the workpiece. The cutting edge of a cutting tool has been formed by scanning a cylindrical irradiation region including a focused spot of laser light over a diamond-coated layer.

### BRIEF DESCRIPTION OF DRAWINGS

FIG. 1 is a diagram showing a schematic structure of a skiving machine according to an embodiment.

FIG. 2 is a diagram for describing pulsed laser grinding.

FIG. 3 is a diagram showing a process of grinding a diamond-coated chip base material with pulsed laser.

FIG. 4 is a cross-sectional view of a workpiece.

### DESCRIPTION OF EMBODIMENTS

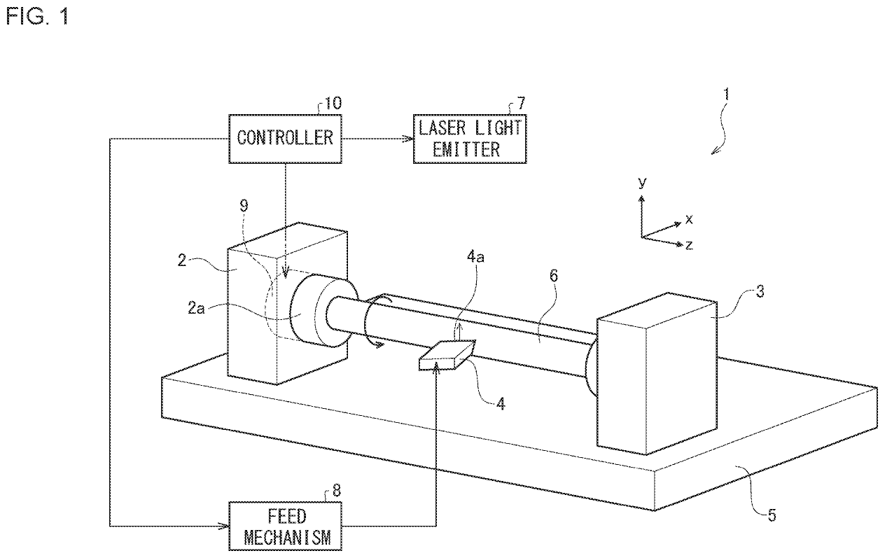

FIG. 1 is a diagram showing a schematic structure of a skiving machine 1 according to an embodiment. The skiving machine 1 shown in FIG. 1 is a cutting apparatus that performs a hard skiving process by causing a cutting edge 4a of a cutting tool 4 to cut into a workpiece 6 having a cylindrical shape, a conical shape, or the like. The skiving machine 1 shown in FIG. 1 may be used for finishing a hardened steel shaft that is the workpiece 6 having a cylindrical shape.

The skiving machine 1 includes, on a bed 5, a headstock 2 and a tailstock 3 that support the workpiece 6 rotatable, and a feed mechanism 8 that supports the cutting tool 4 and moves the cutting tool 4 relative to the workpiece 6. A rotation mechanism 9 is provided inside the headstock 2 and rotates a spindle 2a to which the workpiece 6 is attached. The feed mechanism 8 moves the cutting tool 4 in X-axis, Y-axis, and Z-axis directions. In FIG. 1, the X-axis direction is a horizontal direction and a depth-of-cut direction orthogonal to a rotation axis of the workpiece 6, the Y-axis direction is a vertical direction and a cutting direction orthogonal to the rotation axis of the workpiece 6, and the Z-axis direction is a direction parallel to the rotation axis of the workpiece 6.

A controller 10 controls the rotation mechanism 9 to rotate the spindle 2a and controls the feed mechanism 8 to cause the cutting edge 4a of the cutting tool 4 to cut into the workpiece 6 while the spindle 2a is rotating. The rotation mechanism 9 and the feed mechanism 8 each include a drive unit such as a motor, and the controller 10 regulates power to be supplied to each drive unit to control the operation of a corresponding one of the rotation mechanism 9 and the feed mechanism 8. During a skiving process, the feed mechanism 8 feeds the cutting edge 4a positioned obliquely relative to the rotation axis of the workpiece 6 in a direction containing a cutting direction component orthogonal to the rotation axis with the cutting edge 4a cutting into the workpiece 6.

The cutting edge 4a used in the skiving process is a straight cutting edge and is positioned obliquely relative to the rotation axis (Z-axis direction) of the workpiece 6 on a tangent to the workpiece 6 (YZ plane). With the cutting edge 4a cutting into the workpiece 6, the feed mechanism 8 feeds the cutting edge 4a in a feed direction containing the cutting direction component (Y-axis direction component) orthogonal to the rotation axis on the tangent to machine a surface of the workpiece 6. At this time, the feed mechanism 8 feeds the cutting edge 4a in the feed direction containing a component intersecting a direction parallel to a straight tool tip of the cutting edge 4a, that is, a component orthogonal to the direction parallel to the straight tool tip of the cutting edge 4a. While feeding the cutting edge 4a, the feed mechanism 8 may keep an angle of the straight tool tip relative to the rotation axis constant. Feeding the cutting edge 4a positioned obliquely relative to the rotation axis in the cutting direction shifts a contact point (cutting point) of the straight cutting edge 4a with the workpiece 6 and also shifts a part (point) of the workpiece 6 cut by the straight cutting edge 4a along the rotation axis.

According to the embodiment, the cutting edge 4a of the cutting tool 4 has been formed by grinding a diamond-coated chip base material with pulsed laser.

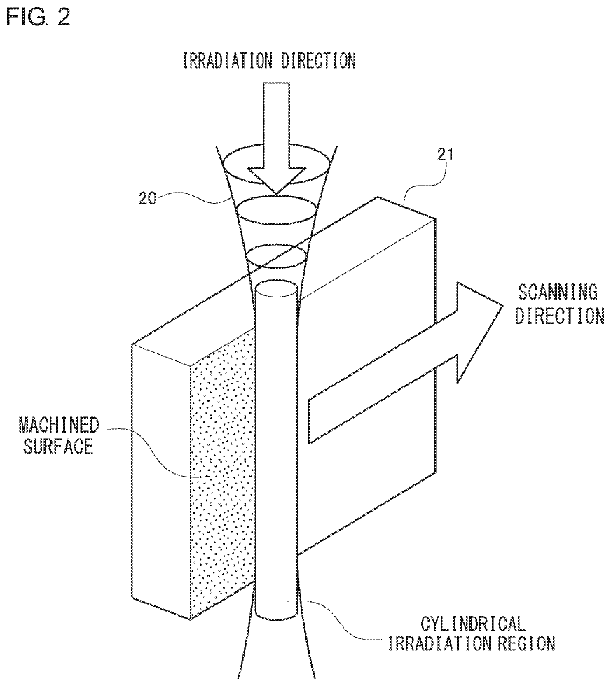

FIG. 2 is a diagram for describing pulsed laser grinding. The pulsed laser grinding is a machining method of overlapping a cylindrical irradiation region extending in an optical axis direction of laser light 20 and having energy enough to make machining with a surface of a workpiece 21 and scanning the cylindrical irradiation region in a direction intersecting the optical axis to remove a surface region of the workpiece 21 where the cylindrical irradiation region has passed. In the pulsed laser grinding, a surface parallel to the optical axis direction and scanning direction is formed on the surface of the workpiece 21. For example, JP2016-159318 A discloses a laser machining apparatus that performs pulsed laser grinding.

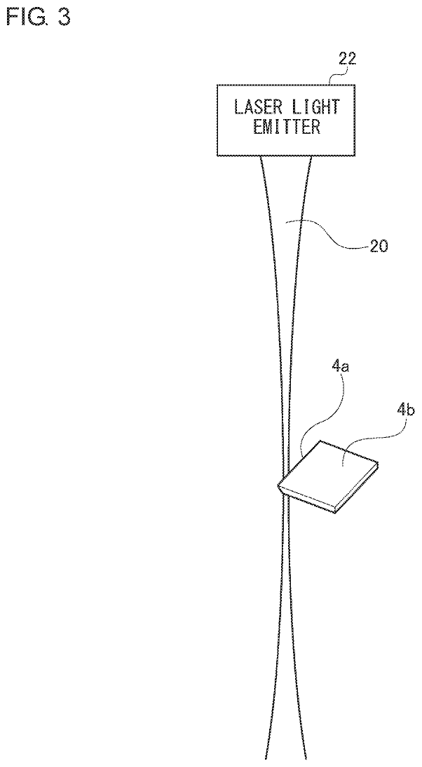

FIG. 3 is a diagram showing a process of grinding a diamond-coated chip base material 4b with pulsed laser. A laser light emitter 22 includes components such as a laser oscillator that generates laser light, an attenuator that adjusts output of the laser light, and a beam expander that adjusts a diameter of the laser light, and is structured to output, through an optical lens, the laser light that has passed through the components. For example, the laser oscillator may generate Nd: YAG pulsed laser light.

The chip base material 4b having an approximately rectangular shape has one side coated with diamond. The diamond-coated layer is formed over the one side of the chip base material 4b by, for example, plasma chemical vapor deposition (CVD). The cylindrical irradiation region including a focused spot of the laser light is scanned over the diamond-coated layer to form the cutting edge 4a that is long and sharp. During this process, the laser light emitter 22 remains stationary, and the chip base material 4b is moved in a specific direction while the cylindrical irradiation region including the focused spot of the laser light 20 is applied to the diamond-coated layer of the chip base material 4b to form the sharp straight cutting edge 4a on the one side of the chip base material 4b.

Since the diamond-coated layer is higher in laser light energy absorption rate than monocrystalline diamond, CBN, or the like, it is possible for pulsed laser grinding to form cutting edges with high efficiency. Further, since the diamond-coated layer is less liable to damage and high in hardness, there is an advantage that sharp cutting edge tips can be easily formed at low cost. The skiving machine 1 according to the embodiment uses the cutting tool 4 having the diamond cutting edge 4a which has been machined to be sharp by pulsed laser.

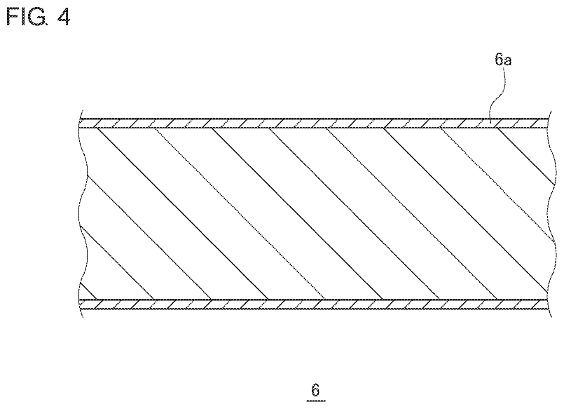

FIG. 4 is a cross-sectional view of the workpiece 6. The workpiece 6 has a solid solution layer 6a on a surface, the solid solution layer 6a containing nitrogen atoms as interstitial solid solution atoms. The workpiece 6 is an iron-based material that is a steel material in the embodiment, but may be a different type of metal. The skiving machine 1 according to the embodiment machines the solid solution layer 6a on the surface of the workpiece 6 using the straight cutting edge 4a which has been obtained by grinding the diamond-coated layer with pulsed laser.

The solid solution layer 6a is formed by diffusing and incorporating nitrogen atoms into the surface of the workpiece 6. The solid solution layer 6a may be formed, for example, by disposing the workpiece 6 in a dilute gas containing nitrogen atoms and irradiating the dilute gas with an electron beam for excitation. Note that a depth of the solid solution layer 6a is restricted to 100 micrometers or less.

It is preferable that the solid solution layer 6a be substantially free of iron nitride. When the solid solution layer 6a contains iron nitrides, the diamond cutting edge 4a may be damaged during cutting. Therefore, forming the solid solution layer 6a without containing iron nitrides can make the life of the cutting tool 4 longer and make surface roughness after cutting smaller.

The solid solution layer 6a may be formed by the electron-beam-excited-plasma nitriding method disclosed in JP2018-135596 A. The electron-beam-excited-plasma nitriding method is a method in which nitrogen atoms enter and diffuse from the surface of the workpiece 6 using plasma containing nitrogen atoms. Since the solid solution layer 6a formed by the electron-beam-excited-plasma nitriding method does not contain iron nitrides, the electron-beam-excited-plasma nitriding method is a preferable forming method.

For the hard skiving process according to an example, the use of the cutting tool 4 that is an inexpensive diamond-coated tool, and the formation of the solid solution layer 6a on the surface of the workpiece 6 can avoid tool wear caused by carbon atoms of the cutting edge 4a entering the workpiece 6. This allows the long cutting edge 4a to be kept sharp over a long cutting distance and allows mirror finishing to be applied to an iron-based material including hardened steel at low cost and with high efficiency. Note that FIG. 4 shows the solid solution layer 6a formed on the surface of the workpiece 6 by nitriding, but the solid solution layer 6a may be formed by diffusing and incorporating phosphorus atoms by NiP plating.

Returning to FIG. 1, the skiving machine 1 may include a laser light emitter 7. The laser light emitter 7 may be identical in structure to the laser light emitter 22 (see FIG. 3) used for forming a cutting edge. The skiving machine 1 including the laser light emitter 7 is capable of resharpening, when the cutting edge 4a of the cutting tool 4 has worn, the cutting edge 4a by pulsed laser grinding using the laser light emitter 7 on the skiving machine 1 without detaching the cutting tool 4.

When the skiving machine 1 is equipped with the laser light emitter 7, the feed mechanism 8 that moves the cutting tool 4 relative to the workpiece 6 during the hard skiving process can be also used during the pulsed laser grinding using the laser light emitter 7 to move the cutting tool 4 relative to the laser light 20, thereby allowing a reduction in total cost of the equipment. Further, the controller 10 can accurately determine the position of the cutting edge 4a formed on the skiving machine 1, so that it is possible to eliminate the need of increasing or decreasing the stock amount of the solid solution layer 6a due to inaccuracy of the tool cutting edge position. The depth of the solid solution layer 6a is equal to or less than 100 micrometers, and the stock amount cannot be increased accordingly, so that it is advantageous for mirror surface cutting of the thin solid solution layer 6a that the cutting edge 4a can be resharpened on the skiving machine 1. Note that the cutting edge 4a can be resharpened on the skiving machine 1, so that a machining error caused by a mounting error can be reduced as compared with a case where the cutting tool 4 is detached and then resharpened.

The present disclosure has been described on the basis of the embodiment. It is to be understood by those skilled in the art that the embodiment is illustrative and that various modifications are possible for a combination of components or processes, and that such modifications are also within the scope of the present disclosure.

The outline of an aspect of the present disclosure is as follows. A skiving machine according to an aspect of the present disclosure includes a rotation mechanism structured to rotate a spindle to which a workpiece is attached, and a feed mechanism structured to feed a cutting edge positioned obliquely relative to a rotation axis of the workpiece in a direction containing a cutting direction component orthogonal to the rotation axis with the cutting edge cutting into the workpiece. The cutting edge of a cutting tool has been formed by scanning a cylindrical irradiation region including a focused spot of laser light over a diamond-coated layer.

According to this aspect, the use of the cutting edge formed of the diamond-coated layer ground with pulsed laser allows a skiving process to be performed with high efficiency.

A solid solution layer containing interstitial solid solution atoms is preferably provided on the surface of the workpiece. The formation of the solid solution layer on the surface of the workpiece can make the life of the cutting edge longer.

The skiving machine may further include a laser light emitter structured to scan the cylindrical irradiation region of laser light over the cutting edge of the cutting tool. The skiving machine including the laser light emitter is capable of resharpening the cutting edge without detaching the cutting tool from the skiving machine.

Another aspect of the present disclosure is a skiving method for machining a surface of a workpiece by feeding a cutting edge positioned obliquely relative to a rotation axis of the workpiece in a direction containing a cutting direction component orthogonal to the rotation axis with the cutting edge cutting into the workpiece. The cutting edge of a cutting tool has been formed by scanning a cylindrical irradiation region including a focused spot of laser light over a diamond-coated layer.

According to this aspect, the use of the cutting edge formed of the diamond-coated layer ground with pulsed laser allows a skiving process to be performed with high efficiency.

### INDUSTRIAL APPLICABILITY

The present disclosure is applicable to a skiving process.

### REFERENCE SIGNS LIST

1 skiving machine, 4 cutting tool, 4a cutting edge, 6 workpiece, 6a solid solution layer, 7 laser light emitter, 8 feed mechanism, 9 rotation mechanism, 10 controller

1. A skiving machine comprising:
a rotation mechanism structured to rotate a spindle to which a workpiece is attached; and
a feed mechanism structured to feed a straight cutting edge of a cutting tool positioned obliquely relative to a rotation axis of the workpiece in a direction containing a cutting direction component orthogonal to the rotation axis with the straight cutting edge cutting into the workpiece, a contact point of the straight cutting edge of the cutting tool with the workpiece being shifted from one end of the straight cutting edge toward another end to machine a surface of the workpiece, wherein
a solid solution layer containing interstitial solid solution atoms is provided on the surface of the workpiece, and
the straight cutting edge of a cutting tool has been formed by scanning a cylindrical irradiation region including a focused spot of laser light over a diamond-coated layer.

2. (canceled)

3. (canceled)

4. A skiving method for machining a surface of a workpiece by feeding a straight cutting edge of a cutting tool positioned obliquely relative to a rotation axis of the workpiece in a direction containing a cutting direction component orthogonal to the rotation axis with the straight cutting edge cutting into the workpiece and shifting a contact point of the straight cutting edge of the cutting tool with the workpiece from one end of the straight cutting edge toward another end, wherein
a solid solution layer containing interstitial solid solution atoms is provided on the surface of the workpiece, and
the straight cutting edge of a cutting tool has been formed by scanning a cylindrical irradiation region including a focused spot of laser light over a diamond-coated layer.

5. The skiving machine according to claim 1, further comprising a laser light emitter structured to scan the cylindrical irradiation region of laser light over the straight cutting edge of the cutting tool, wherein
the feed mechanism moves the cutting tool relative to the workpiece during machining, and moves the cutting tool relative to the laser light during laser grinding.

6. The skiving machine according to claim 5, wherein
the solid solution layer has a depth of 100 micrometers or less.
